(19) United States
(12) Patent Application Publication
(10) Pub. No.: US 2025/0104724 A1
(43) Pub. Date: Mar. 27, 2025

(54) METHOD AND APPARATUS FOR ENCODING/DECODING NEURAL NETWORK-BASED PERSONALIZED SPEECH

(71) Applicants: Electronics and Telecommunications Research Institute, Daejeon (KR); The Trustees of Indiana University, Bloomington, IN (US)

(72) Inventors: Inseon JANG, Daejeon (KR); Soo Young PARK, Daejeon (KR); Seung Kwon BEACK, Daejeon (KR); Jongmo SUNG, Daejeon (KR); Woo-taek LIM, Daejeon (KR); Byeongho CHO, Daejeon (KR); Jung Won KANG, Daejeon (KR); Tae Jin LEE, Daejeon (KR); Minje KIM, Bloomington, IN (US); Haici YANG, Bloomington, IN (US)

(73) Assignees: Electronics and Telecommunications Research Institute, Daejeon (KR); The Trustees of Indiana University, Bloomington, IN (US)

(21) Appl. No.: 18/886,296

(22) Filed: Sep. 16, 2024

Related U.S. Application Data
(60) Provisional application No. 63/585,547, filed on Sep. 26, 2023.

(30) Foreign Application Priority Data
Mar. 5, 2024 (KR) 10-2024-0031297

(51) Int. Cl. G10L 19/16

(52) U.S. Cl. CPC G10L 19/16

(57) ABSTRACT

A method and apparatus for encoding/decoding a neural network-based personalized speech are provided. The method includes outputting a first bit stream in which an input speech signal is encrypted, based on the input speech signal, and outputting a second bit stream in which speaker information of the input speech signal is encrypted, based on the input speech signal.

### CROSS-REFERENCE TO RELATED APPLICATION

This application claims the benefit of U.S. Provisional Application No. 63/585,547, filed on Sep. 26, 2023, in the U.S. Patent and Trademark Office, and claims the benefit of Korean Patent Application No. 10-2024-0031297, filed on Mar. 5, 2024, in the Korean Intellectual Property Office, the entire disclosures of which are incorporated herein by reference for all purposes.

### BACKGROUND

### 1. Field of the Invention

One or more embodiments relate to a method and apparatus for encoding/decoding a neural network-based personalized speech.

### 2. Description of the Related Art

Adaptive coding may be a coding technique of dynamically adjusting an encoding parameter according to characteristics of a speech signal that is generally processed. Adaptive coding may efficiently represent and transmit a speech while adapting to various environmental conditions in which a speech signal is generated. Various environmental conditions may include changing conditions such as changes in speech content, fluctuations in background noise, or changes in the speech of a speaker.

The above description has been possessed or acquired by the inventor(s) in the course of conceiving the present disclosure and is not necessarily an art publicly known before the present application is filed.

### SUMMARY

Embodiments may provide a technique of restoring a speech signal through a decoder trained differently depending on a speaker group of the speech signal, in order to improve quality of the restored speech signal.

However, the technical aspects are not limited to the aforementioned aspects, and other technical aspects may be present.

According to an aspect, there is provided a method of encoding an input speech signal, the method including outputting a first bit stream in which the input speech signal is encrypted, based on the input speech signal, and outputting a second bit stream in which speaker information of the input speech signal is encrypted, based on the input speech signal.

The outputting of the second bit stream may include determining a first speaker group to which a speaker of the input speech signal belongs, based on the input speech signal, and generating the second bit stream by encrypting information about the first speaker group.

The determining of the first speaker group may include obtaining a feature vector about a speaker of the input speech signal, based on the input speech signal, and determining the first speaker group based on the feature vector.

The determining of the first speaker group may include calculating probabilities that the speaker of the input speech signal belongs to each of a plurality of speaker groups, based on the feature vector, and determining a speaker group with a highest probability among the plurality of speaker groups as the first speaker group.

According to another aspect, there is provided an electronic device for encoding an input speech signal, the electronic device including a processor and a memory configured to store instructions, wherein the instructions, when executed by the processor, may cause the electronic device to output a first bit stream in which the input speech signal is encrypted, based on the input speech signal, and output a second bit stream in which speaker information of the input speech signal is encrypted, based on the input speech signal.

The instructions, when executed by the processor, may cause the electronic device to determine a first speaker group to which a speaker of the input speech signal belongs, based on the input speech signal, and generate the second bit stream by encrypting information about the first speaker group.

The instructions, when executed by the processor, may cause the electronic device to obtain a feature vector about a speaker of the input speech signal, based on the input speech signal, and determine the first speaker group based on the feature vector.

The instructions, when executed by the processor, may cause the electronic device to calculate probabilities that the speaker of the input speech signal belongs to each of a plurality of speaker groups, based on the feature vector, and determine a speaker group with a highest probability among the plurality of speaker groups as the first speaker group.

According to another aspect, there is provided a method of decoding a speech signal, the method including receiving a first bit stream in which the speech signal is encrypted and a second bit stream in which speaker information of the speech signal is encrypted and generating a restored speech signal differently according to a speaker group to which a speaker of the speech signal belongs, based on the first bit stream and the second bit stream.

The generating of the restored speech signal differently according to the speaker group may include selecting a personalized decoder corresponding to the speaker group, based on the second bit stream, and outputting the restored speech signal through the personalized decoder, based on the first bit stream.

The personalized decoder may be a neural vocoder trained based on a speech signal corresponding to the speaker group.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an example of an encoder and a decoder, according to an embodiment;

FIG. 2 illustrates an example of an encoder shown in FIG. 1;

FIG. 3 is a diagram illustrating an operation of clustering a plurality of speech signals, according to an embodiment;

FIG. 4 illustrates an example of a decoder shown in FIG. 1;

FIG. 5 illustrates an example of a personalized decoder shown in FIG. 4;

FIG. 6 illustrates an example of a flowchart of a speech signal encoding method according to an embodiment;

FIG. 7 illustrates an example of a flowchart of a speech signal decoding method according to an embodiment; and

FIG. 8 illustrates an example of an electronic device according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, the embodiments will be described in detail with reference to the accompanying drawings. When describing the embodiments with reference to the accompanying drawings, like reference numerals refer to like components and a repeated description related thereto will be omitted.

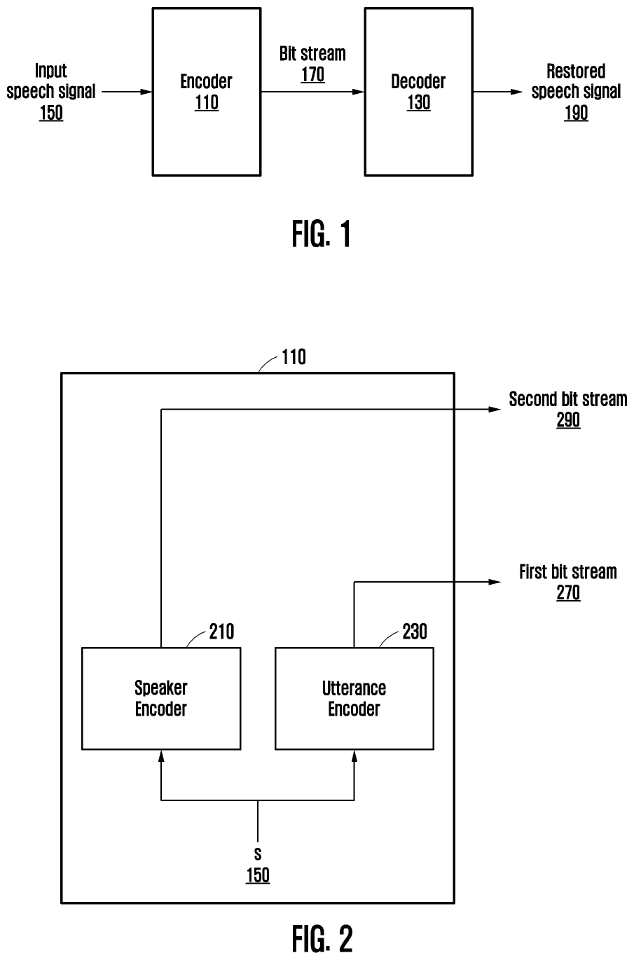

FIG. 1 illustrates an example of an encoder and a decoder, according to an embodiment.

Referring to FIG. 1, a speech signal coding apparatus may include an encoder 110 and/or a decoder 130.

The encoder 110 may encode an input speech signal 150 to generate a bit stream 170 and may transmit (or output) the bit stream 170 to the decoder 130. The encoder 110 is described in detail with reference to FIG. 2.

The bit stream 170 may include a first bit stream and a second bit stream. The first bit stream may be a bit stream in which the input speech signal 150 is encrypted and the second bit stream may be a bit stream in which speaker information of the input speech signal 150 is encrypted.

The decoder 130 may decode the bit stream 170 obtained (e.g., received) from the encoder 110 to generate a restored speech signal 190. The decoder 130 may generate the restored speech signal 190 differently according to a speaker of the input speech signal 150. For example, the decoder 130 may obtain information about a speaker group to which the speaker of the input speech signal 150 belongs, based on the bit stream 170. The decoder 130 may select a decoder according to the speaker of the input speech signal 150, based on information about the speaker group. The decoder according to the speaker of the input speech signal 150 may be a personalized decoder (e.g., a decoder trained based on speech signals of the speaker group to which the speaker of the input speech signal 150 belongs). Restoring the bit stream 170 through a personalized decoder may improve the quality of the restored speech signal 190 at the same bit rate compared to restoring the bit stream 170 through a non-personalized decoder (e.g., a decoder that is not trained according to each speaker group).

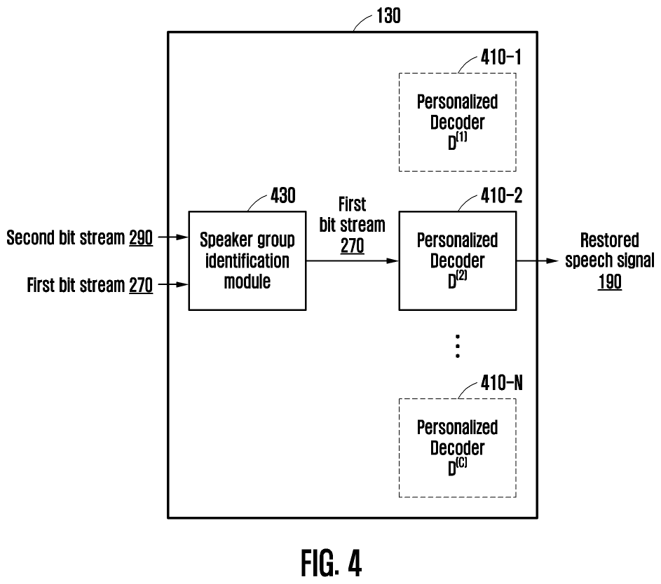

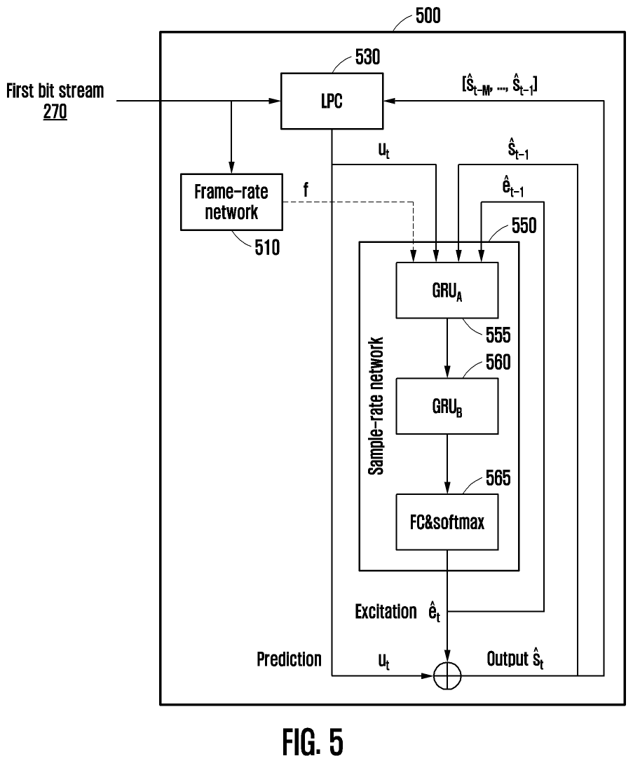

The configuration and operation of the decoder 130 are described in detail with reference to FIGS. 4 and 5.

FIG. 2 illustrates an example of an encoder shown in FIG. 1.

Referring to FIG. 2, the encoder 110 may include a speaker encoder 210 and an utterance encoder 230.

The speaker encoder 210 may output a second bit stream 290 based on the input speech signal 150. The second bit stream 290 may be a bit stream in which speaker information of the input speech signal 150 is encrypted. The speaker information of the input speech signal 150 may include information about which speaker group among a plurality of speaker groups the speaker of the input speech signal 150 belongs to.

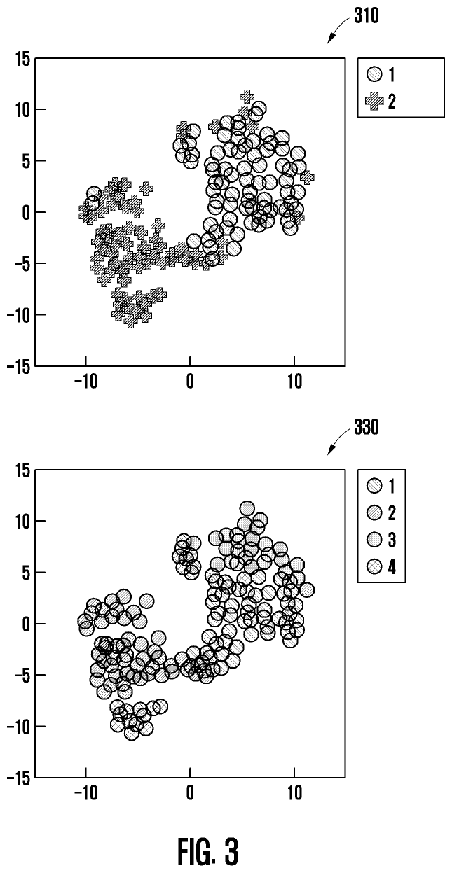

The speaker encoder 210 may determine a first speaker group to which the speaker of the input speech signal 150 belongs, based on the input speech signal 150. The first speaker group may be any one of the plurality of speaker groups. The plurality of speaker groups may be a plurality of speech signals classified by speaker. For example, speech signals from a same speaker may be classified into a same speaker group. However, embodiments are not limited thereto, and speech signals of speakers with similar acoustic characteristics, as well as a same speaker, may be classified into a same speaker group. A method of classifying the plurality of speech signals into the plurality of speaker groups is described in detail with reference to FIG. 3.

The speaker encoder 210 may obtain a feature vector about the speaker of the input speech signal 150, based on the input speech signal 150. The speaker encoder 210 may be trained to output feature vectors about a speaker of a speech signal based on the plurality of speech signals. Feature vectors (e.g., the feature vectors about the speaker of the speech signal) may be defined in an embedding space. For example, the speaker encoder 210 may be implemented as a Siamese network. A Siamese network may be trained to output a feature vector in which input data is embedded, based on similarity between input data (e.g., the plurality of speech signals). The plurality of speech signals may include speech signals for training of the speaker encoder 210. The speaker encoder 210 may be trained based on the plurality of speech signals. The trained speaker encoder 210 may output a feature vector corresponding to each of the plurality of speech signals, based on the plurality of speech signals. Specifically, the speaker encoder 210 may be trained through the loss function of Equation 1 below.

$$ℒ = - {\sum }_{\begin{matrix}i , j ∼ {𝕊}^{( k )} , \\ ∀ k\end{matrix}} log σ ( {z}_{i}^{T} {z}_{j} ) - {\sum }_{\begin{matrix}i ∼ {𝕊}^{( k )} , j ∼ {𝕊}^{( {k}^{′} )} , \\ k \neq {k}^{′}\end{matrix}} log ( 1 - σ ( {z}_{i}^{T} {z}_{j} ) ) \qquad [ Equation 1 ]$$

In Equation 1, [symbol] denotes a loss function for training the speaker encoder 210, [symbol] ^{(k)} denotes a speech signal of a k-th speaker, zᵢ denotes a feature vector of a speech signal of an i-th speaker, zⱼ denotes a feature vector of a speech signal of a j-th speaker, and σ denotes a sigmoid function.

The number of feature vectors may correspond to the number of speakers in the speech signal. That is, when there are “251” speakers in the speech signal, there may be a total of “251” feature vectors.

The speaker encoder 210 may determine the first speaker group based on the feature vector about the speaker of the input speech signal 150. The first speaker group may be a speaker group to which the speaker of the input speech signal 150 belongs. The speaker encoder 210 may calculate probabilities that the speaker of the input speech signal 150 belongs to each of the plurality of speaker groups, based on the feature vector. The speaker encoder 210 may determine a speaker group with the highest probability (e.g., the probability that the speaker of the input speech signal 150 belongs to a corresponding speaker group) among the plurality of speaker groups as the first speaker group. For example, for ease of description, it is assumed that there are speaker groups from the first speaker group to an n-th speaker group. The speaker encoder 210 may calculate the probability that the speaker of the input speech signal 150 belongs to the speaker groups, from the first speaker group to the n-th speaker group, for each speaker group, based on the feature vector. The speaker encoder 210 may determine the n-th speaker group among the plurality of speaker groups as the first speaker group, when the probability that the speaker of the input speech signal 150 belongs to the n-th speaker group is the highest. Probability calculation may be performed through a soft max function. However, this is only an example of the present disclosure, and the scope of the present disclosure is not limited thereto.

The speaker encoder 210 may encrypt information about the first speaker group to generate a second bit stream. When the plurality of speaker groups has a total of “C” speaker groups, the second bit stream may be assigned “log₂ C” bits. For example, when there is a total of “4” speaker groups, the second bit stream may be assigned “2” bits. When the first speaker group corresponds to a third speaker group among the “4” speaker groups, the second bit stream may be (1.0).

The utterance encoder 230 may output a first bit stream based on the input speech signal 150. The first bit stream may include a bit stream in which the input speech signal 150 is encrypted. The first bit stream may be in the form of an L-dimensional binary vector.

FIG. 3 is a diagram illustrating an operation of clustering a plurality of speech signals, according to an embodiment.

Referring to FIG. 3, a graph 310 represents a case where there are two speaker groups and a graph 330 represents a case where there are four speaker groups.

The speaker encoder 210 may obtain feature vectors about speakers of speech signals, based on a plurality of speech signals. The method of obtaining feature vectors is described in detail with reference to FIG. 2, so the description thereof is omitted below.

The speaker encoder 210 may classify the plurality of speech signals into a plurality of speaker groups by clustering a plurality of feature vectors (e.g., feature vectors about speakers of the plurality of speech signals obtained by embedding the plurality of speech signals). For example, the speaker encoder 210 may perform K-means clustering on the feature vectors in an embedding space (e.g., an embedding space in which the plurality of feature vectors is defined). When the K-means clustering is performed on the feature vectors, the more similar the features (or characteristics) (e.g., acoustic characteristics) are, the closer the feature vectors may be located in the embedding space. The speaker encoder 210 may group the feature vectors based on the number of preset speaker groups.

The graph 310 shows a result of clustering each of the feature vectors into the first speaker group and the second speaker group when there are two speaker groups in total. The graph 330 shows a result of clustering each of the feature vectors into the first speaker group to the fourth speaker group when there are four speaker groups in total.

FIG. 4 illustrates an example of a decoder shown in FIG. 1.

Referring to FIG. 4, the decoder 130 may include a plurality of personalized decoders 410-1 to 410-N and a speaker group identification module 430. The decoder 130 may generate the restored speech signal 190 based on a bit stream (e.g., the bit stream 170 of FIG. 1, a first bit stream 270, and/or the second bit stream 290).

The decoder 130 may generate a restored speech signal differently according to a speaker group to which a speaker of a speech signal belongs, based on the first bit stream 270 and the second bit stream 290.

The speaker group identification module 430 may identify a speaker group of a speech signal based on the second bit stream 290. The speaker group identification module 430 may identify the speaker group of the speech signal by parsing the second bit stream 290. For example, the speaker group identification module 430 may obtain the speaker group of the speech signal based on the second bit stream 290. When there is a total of “4” speaker groups and the second bit stream 290 is (0,1), the speaker group identification module 430 may identify that the speaker group of the speech signal is the second speaker group.

The speaker group identification module 430 may transmit the first bit stream 270 to a personalized decoder (e.g., any one of the personalized decoders 410-1 to 410-N) corresponding to the identified speaker group. For example, the speaker group identification module 430 may select a decoder (e.g., a personalized decoder 410-2) corresponding to the identified speaker group (e.g., the second speaker group among the four speaker groups) as a decoder for restoring the speech signal. The speaker group identification module 430 may transmit (or output) the first bit stream 270 to the selected decoder (e.g., the personalized decoder 410-2).

The personalized decoder 410-2 may generate the restored speech signal 190 based on the first bit stream 270. Here, the personalized decoder 410-2 may be a decoder trained based on the speech signal corresponding to the second speaker group and may generate the restored speech signal 190 of higher quality than other decoders (e.g., the personalized decoders 410-1 and 410-3 to 410-N). Hereinafter, with reference to FIG. 5, a method of training the personalized decoders 410-1 to 410-N based on a speech signal corresponding to a specific speaker group is described.

FIG. 5 illustrates an example of a personalized decoder shown in FIG. 4.

Referring to FIG. 5, a personalized decoder 500 (e.g., the personalized decoders 410-1 to 410-N of FIG. 4) may be a linear predictive coding (LPC) network. The LPC network may be a decoder that combines LPC and a wave recurrent neural network (RNN).

The personalized decoder 500 may be trained based on a speech signal corresponding to a specific speaker group (e.g., a second speaker group). The personalized decoder 410-2 may be a neural vocoder trained based on the speech signal corresponding to the specific speaker group (e.g., an n-th speaker group). For ease of description, it is assumed that the first bit stream 270 is a bit stream in which the speech signal of the specific speaker group (e.g., the speech signal of the n-th speaker group) is encrypted. That is, hereinafter, the first bit stream 270 is a bit stream in which the speech signal of the n-th speaker group is encrypted and does not include a speech signal of any other speaker group other than the n-th speaker group.

The personalized decoder 500 may include a frame-rate network 510, an LPC module 530, and a sample-rate network 550. The sample-rate network 550 may include a gated recurrent unit (GRUA) 555, a GRUB 560, and a soft max module 565.

The LPC module 530 may obtain a predicted speech signal (e.g., uₜ) at a current point in time, based on the first bit stream 270 and a speech signal (e.g., [ŝ_{t-M}, . . . , ŝₜ₋₁]) at a previous point in time. The LPC module 530 may obtain the predicted speech signal (e.g., uₜ) at the current point in time through Equation 2 below.

$${u}_{t} = {\sum }_{m = 1}^{M} {a}_{m} {s}_{t - m} \qquad [ Equation 2 ]$$

In Equation 2, uₜ denotes the predicted speech signal at the current point in time, sₜ₋ₘ denotes a speech signal at a t-m-th previous point in time, aₘ denotes an LPC coefficient of a speech signal at an m-th previous point in time, and M denotes a prediction order.

The frame-rate network 510 may obtain a frame feature vector about the frame rate of the first bit stream 270, based on the first bit stream 270. For example, the frame-rate network 510 may convert the first bit stream 270 into the frame feature vector (e.g., f) for each 10 milliseconds (ms) frame of the first bit stream 270.

The sample rate network 550 may obtain an excitation signal (e.g., êₜ) at the current point in time, based on the speech signal (e.g., [ŝ_{t-M}, . . . , ŝₜ₋₁]) at the previous point in time, the predicted speech signal (e.g., uₜ) at the current point in time, and an excitation signal (e.g., êₜ₋₁) at the previous point in time. The sample rate network 550 may obtain the frame feature vector (e.g., f) from the frame-rate network 510 for each frame. The sample rate network 550 may predict the probability (e.g., P(eₜ)) that the excitation signal (e.g., êₜ) at the current point in time is sampled.

The personalized decoder 500 may generate the speech signal (e.g., ŝₜ) at the current point in time, based on the excitation signal (e.g., êₜ) at the current point in time and the predicted speech signal (e.g., uₜ) at the current point in time. For example, the personalized decoder 500 may generate the speech signal (e.g., ŝₜ) at the current point in time by adding the predicted speech signal (e.g., uₜ) at the current point in time to the excitation signal (e.g., êₜ) at the current point in time.

The above-described excitation signal, speech signal, and/or predicted speech signal may operate in an 8-bit u-law domain.

The personalized decoder 500 may be trained based on cross entropy between the excitation signal (e.g., êₜ). Specifically, the personalized decoder 500 may be trained through the loss function of Equation 3 below.

$${\sum }_{i ∈ {𝕊}^{( k )} , k ∈ {ℍ}^{( c )}} {ℒ}_{CE} ( {\hat{e}}_{i} ‖ {e}_{i} ) \qquad [ Equation 3 ]$$

In Equation 3, [symbol] CE denotes a cross entropy loss function, êᵢ denotes the excitation signal at the current point in time generated by the personalized decoder 500, eᵢ denotes ground truth of the excitation signal at the current point in time.

As described above, it is assumed that the first bit stream 270 is a bit stream in which the speech signal of the n-th speaker group is encrypted, but the training method of the personalized decoder 500 described above may be performed for each speaker group.

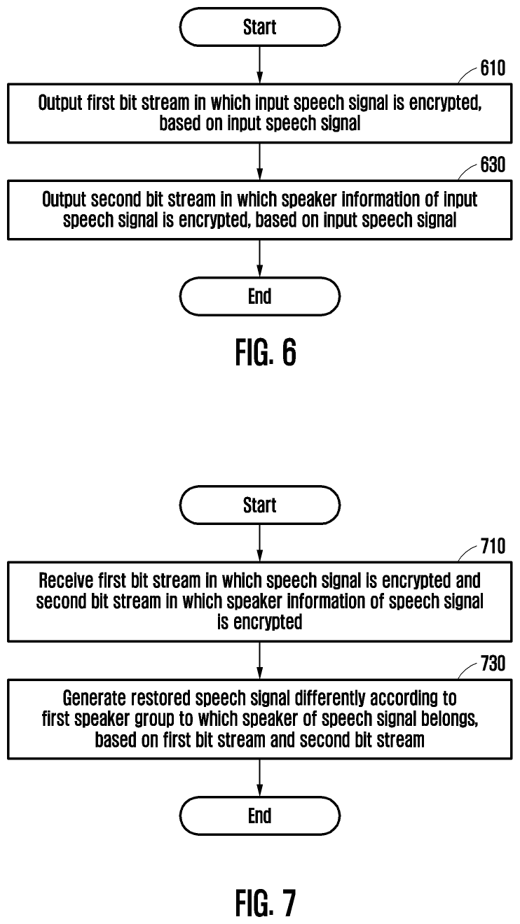

FIG. 6 illustrates an example of a flowchart of a speech signal encoding method according to an embodiment.

Referring to FIG. 6, operations 610 and 630 may be performed sequentially but are not limited thereto. For example, two or more operations may be performed in parallel.

Operations 610 and 630 may be substantially the same as the operation of an encoder (e.g., the encoder 110 of FIG. 1) described with reference to FIGS. 1 to 5. Accordingly, further description thereof is not repeated herein.

In operation 610, the encoder 110 may output a first bit stream in which the input speech signal 150 is encrypted, based on the input speech signal 150.

In operation 630, the encoder 110 may output a second bit stream in which speaker information of the input speech signal 150 is encrypted, based on the input speech signal 150.

FIG. 7 illustrates an example of a flowchart of a speech signal decoding method according to an embodiment.

Referring to FIG. 7, operations 710 and 730 may be performed sequentially but are not limited thereto. For example, two or more operations may be performed in parallel. Operations 710 and 730 may be substantially the same as the operation of a decoder (e.g., the decoder 130 of FIG. 1) described with reference to FIGS. 1 to 6. Accordingly, further description thereof is not repeated herein.

In operation 710, the decoder 130 may obtain (e.g., receive) a first bit stream in which a speech signal is encrypted and a second bit stream in which speaker information of the speech signal is encrypted.

In operation 730, the decoder 130 may generate a restored speech signal differently according to a speaker group to which a speaker of the speech signal belongs, based on the first bit stream and the second bit stream.

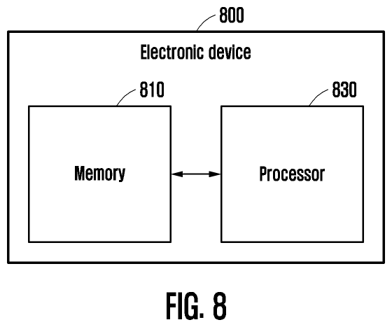

FIG. 8 illustrates an example of an electronic device according to an embodiment.

Referring to FIG. 8, an electronic device 800 may include a memory 810 and a processor 830. The electronic device 800 may include the encoder 110 and/or the decoder 130 of FIG. 1.

The memory 810 may store instructions (or programs) executable by the processor 830. For example, the instructions may include instructions to perform an operation of the processor 830 and/or an operation of each component of the processor 830.

The memory 810 may be implemented as a volatile memory device or a non-volatile memory device.

The volatile memory device may be implemented as dynamic random-access memory (DRAM), static random-access memory (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase-change RAM (PRAM), resistive RAM (RRAM), nanotube RRAM, polymer RAM (PoRAM), nano floating gate memory (NFGM), holographic memory, a molecular electronic memory device, or insulator resistance change memory.

The processor 830 may process data stored in the memory 810. The processor 830 may execute computer-readable code (e.g., software) stored in the memory 810 and instructions triggered by the processor 830.

The processor 830 may be a hardware-implemented data processing device having a circuit that is physically structured to execute desired operations. The desired operations may include, for example, code or instructions in a program.

The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 810 may cause the electronic device 800 to perform one or more operations by executing the instructions and/or code stored in the memory 830. Operations performed by the electronic device 800 may be substantially the same as operations performed by the encoder 110 and/or the decoder 130 described with reference to FIGS. 1 to 7. Accordingly, a repeated description thereof is omitted.

The components described in the embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A method of encoding an input speech signal, the method comprising:
outputting a first bit stream in which the input speech signal is encrypted, based on the input speech signal; and
outputting a second bit stream in which speaker information of the input speech signal is encrypted, based on the input speech signal.

2. The method of claim 1, wherein
the outputting of the second bit stream comprises:
determining a first speaker group to which a speaker of the input speech signal belongs, based on the input speech signal; and
generating the second bit stream by encrypting information about the first speaker group.

3. The method of claim 2, wherein
the determining of the first speaker group comprises:
obtaining a feature vector about a speaker of the input speech signal, based on the input speech signal; and
determining the first speaker group based on the feature vector.

4. The method of claim 3, wherein
the determining of the first speaker group comprises:
calculating probabilities that the speaker of the input speech signal belongs to each of a plurality of speaker groups, based on the feature vector; and
determining a speaker group with a highest probability among the plurality of speaker groups as the first speaker group.

5. An electronic device for encoding an input speech signal, the electronic device comprising:
a processor; and
a memory configured to store instructions,
wherein the instructions, when executed by the processor, cause the electronic device to:
output a first bit stream in which the input speech signal is encrypted, based on the input speech signal; and
output a second bit stream in which speaker information of the input speech signal is encrypted, based on the input speech signal.

6. The electronic device of claim 5, wherein
the instructions, when executed by the processor, cause the electronic device to:
determine a first speaker group to which a speaker of the input speech signal belongs, based on the input speech signal; and
generate the second bit stream by encrypting information about the first speaker group.

7. The electronic device of claim 6, wherein
the instructions, when executed by the processor, cause the electronic device to:
obtain a feature vector about a speaker of the input speech signal, based on the input speech signal; and
determine the first speaker group based on the feature vector.

8. The electronic device of claim 7, wherein
the instructions, when executed by the processor, cause the electronic device to:
calculate probabilities that the speaker of the input speech signal belongs to each of a plurality of speaker groups, based on the feature vector; and
determine a speaker group with a highest probability among the plurality of speaker groups as the first speaker group.

9. A method of decoding a speech signal, the method comprising:
receiving a first bit stream in which the speech signal is encrypted and a second bit stream in which speaker information of the speech signal is encrypted; and
generating a restored speech signal differently according to a speaker group to which a speaker of the speech signal belongs, based on the first bit stream and the second bit stream.

10. The method of claim 9, wherein
the generating of the restored speech signal differently according to the speaker group comprises:
selecting a personalized decoder corresponding to the speaker group, based on the second bit stream; and
outputting the restored speech signal through the personalized decoder, based on the first bit stream.

11. The method of claim 10, wherein
the personalized decoder is a neural vocoder trained based on a speech signal corresponding to the speaker group.
